(19) United States
(12) Patent Application Publication
(10) Pub. No.: US 2003/0050978 A1
(43) Pub. Date: Mar. 13, 2003

(54) Availability alerting apparatus

(76) Inventors: Joseph M. Cannon, Harleysville, PA (US); James A. Johanson, Macungie, PA (US); Philip D. Mooney, Sellersville, PA (US)

Correspondence Address: HITT GAINES & BOISBRUN P.C., P.O. BOX 832570, RICHARDSON, TX, 75083, US

(21) Appl. No.: 09/951,115

(22) Filed: Sep. 13, 2001

(51) Int. Cl. G06F 15/16

(52) U.S. Cl. 709/204; 709/219

(57) ABSTRACT

The present invention provides, for use with a multi-user device, an availability alerting apparatus comprising a device status monitor, a waiting party queue, and a waiting party informant. In a particularly advantageous embodiment, the device status monitor is coupled to the multi-user device and configured to report an inactivity of the multi-user device; the waiting party queue is configured to collect waiting party identifiers; and the waiting party informant is coupled to the device status monitor and the waiting party queue. The waiting party informant is configured to alert a one of the waiting parties when the device status monitor reports the inactivity.

### TECHNICAL FIELD OF THE INVENTION

The present invention is directed, in general, to photocopiers and, more specifically, to an alerting device that notifies a waiting user that a group-use device such as a photocopier, network printer, etc., is available for their use.

### BACKGROUND OF THE INVENTION

The modern office of today frequently has one or more single devices that are shared by a number of employees either through a network, e.g., a network printer, or through time sharing, e.g., photocopier, facsimile machine, etc. While this arrangement is primarily driven by the need to conserve capital funds by having one larger, more capable, piece of equipment that is intermittently used by a large number of employees, the arrangement has the negative aspect that, frequently, more than one employee needs, or wants, to use the same piece of equipment at about the same time. Usually, this demand-greater-than-supply condition is accommodated on a “first come, first served” basis. In some circumstances, especially when a large job must be printed or copied on the shared device, the potential users negotiate when the device will be used by each of them, e.g., one employee interrupts their large job to allow a second employee to run a very small job. Often, however, one user simply waits or goes back to their office only to return again later, while the first user completes their job. In any of these events, at least one employee is not using their time effectively. It is readily apparent that a significant number of person-hours are wasted waiting for copier, printer or fax availability. Other common-use devices, e.g., coffee makers, microwaves, etc., have similar problems.

Accordingly, what is needed in the art is a programmable alerting apparatus that notifies a waiting user that a photocopier, network printer, coffee machine, etc., is available for their use.

### SUMMARY OF THE INVENTION

To address the above-discussed deficiencies of the prior art, the present invention provides, for use with a multi-user device, an availability alerting apparatus comprising a device status monitor, a waiting party queue, and a waiting party informant. In a particularly advantageous embodiment, the device status monitor is coupled to the multi-user device and configured to report an inactivity of the multi-user device; the waiting party queue is configured to collect waiting party identifiers; and the waiting party informant is coupled to the device status monitor and the waiting party queue. The waiting party informant is configured to alert one of the waiting parties when the device status monitor reports the inactivity.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of one embodiment of an availability alerting apparatus constructed according to the principles of the present invention;

FIG. 2 illustrates a block diagram of an alternative embodiment of the device-available alerting apparatus of FIG. 1; and

FIG. 3 illustrates a block diagram of an alternative embodiment of the device-available alerting apparatus of FIG. 1.

### DETAILED DESCRIPTION

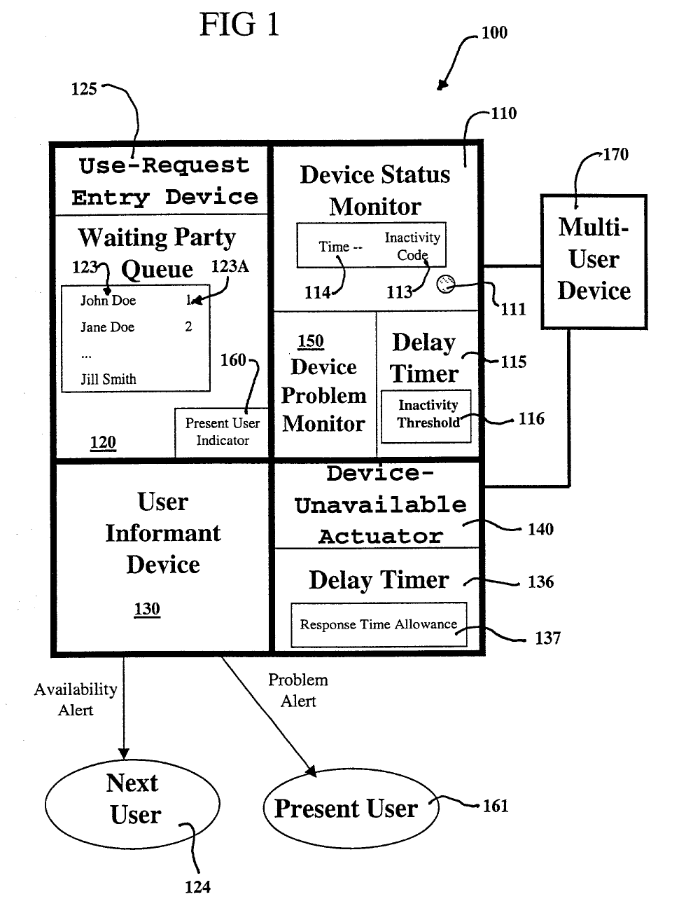

Referring initially to FIG. 1, illustrated is a block diagram of one embodiment of an availability alerting apparatus 100 constructed according to the principles of the present invention. The device-available alerting apparatus 100 comprises a device status monitor 110, a delay timer 115, a waiting party queue 120, a use-request entry device 125, a waiting party informant 130, a device-unavailable actuator 140, a device problem monitor 150, and a present user indicator 160. The device status monitor 110 is coupled to a multi-user device 170 that is available for use by more than one person, except that only one person may use the multi-user device 170 at a time. For example, the multi-user device 170 may be any of a variety of devices including: a photocopier, a printer, a facsimile device, a microwave, a coffee maker, etc. For ease of reference and understanding during the remainder of this discussion, the multi-user device 170 will be represented as the photocopier 170, also referred to as the copier 170. However, one who is skilled in the art will readily recognize that any other multi-user device could likewise be employed with the present invention.

The waiting party queue 120 is configured to collect waiting party identifiers 123 through the use-request entry device 125. The use-request entry device 125 may be a variety of devices in common use today. For example, in its most direct form, the use-request entry device 125 may be an employee badge reader, a computer-based employee selector list, a numeric key entry device (e.g., employee number), an alphameric key entry device, a voice recognition device, or a biometric identification device. In a particularly advantageous embodiment, each of these use-request entry devices 125 may be coupled to the waiting party queue 120. Of course, other indirect devices, e.g., telephone, modem, etc., may also be configured to couple to the waiting party queue 120 allowing a potential user to input the necessary information to schedule a job at the copier 170. One who is skilled in the art is familiar with the details of design and operation of such devices. The waiting party identifiers 123 include a priority indicator 123a configured to associate a priority with a particular user, or that user's copy job. For example, ten copies of an urgent report are required by a department head, but the copier is presently in use by the CEO's secretary. One employee has already input a request by swiping their badge through a badge reader. However, the department head's job may be input by the department secretary using his/her user identifier 123, but with the priority indicator set to “1” indicating that the job is a department top priority. Should another employee need to use the copier 170, they may input their request through any of the use-request entry devices 125 coupled to the waiting party queue 120. All requests are then maintained in priority order in the waiting party queue 120 until satisfied or canceled by the waiting party or by a supervisor. One who is skilled in the art is familiar with the various methods, e.g., a computer list, integral CRT or LCD display, etc., that may be employed to indicate to waiting parties 123 where their request is located in the queue 120.

The device status monitor 110 is configured to report inactivity of the copier 170. For example, the copier 170 has been in use by a user and the job is now complete. The device status monitor 110 determines that the copier 170 is inactive and records an inactivity code 113 associated with the current time 114 and activates the delay timer 115. The delay timer 115 allows an additional, pre-set, amount of delay time, i.e., an inactivity threshold 116, to expire before the device status monitor 110 reports the copier 170 as inactive to the waiting party informant 130. The inactivity threshold 116 may be individually configured by setting the inactivity threshold 116 from about one to several minutes, as desired by the group management. This assures that the next waiting party in the waiting party queue 120 is not alerted unnecessarily while the current user is perhaps re-orienting a book or finding a different section of their original document. Additionally, the device status monitor 110 may be equipped with a “Job Complete” button 111 that the current user presses to notify the device status monitor 110 that the copier 170 is available, thus saving the next waiting party an amount of time equivalent to the inactivity threshold 116.

After the required inactivity threshold 116 has been met, the device status monitor 110 reports the inactivity to the waiting party informant 130, whereupon the waiting party informant 130 obtains the next waiting party identifier 123 from the waiting party queue 120, if necessary by priority code 123a or, if not, then by first request, whichever is appropriate. The waiting party informant 130 may use one or more methods to notify the next waiting party 124. That is, the waiting party informant 130 may be a telephone messager, an alphanumeric pager messager, an e-mail messager, or an audible pager. The waiting party informant 130 may use any of the standard technologies for messages including: telephone, computer network, or even a Bluetooth-coupled device. If more than one messaging technology is available, the waiting party may select one method or more than one at the time the entry is made in the waiting party queue 120. That is, an additional marker (not shown) may be associated with the waiting party identifier 123 and the priority code 123a to inform the waiting party informant 130 what technology to use for the alert. Additionally, the waiting party informant 130 is coupled to the device-unavailable actuator 140 that is coupled to the copier 170. The device-unavailable actuator 140 is configured to prevent any user, other than the next waiting party 124 alerted by the waiting party informant 130, from using the copier 170 while the alerted party 124 is responding to the alert. The device-unavailable actuator 140 is additionally configured with a delay timer 136 to give the alerted party 124 a response time allowance 137 to respond. When the response time allowance 137 has expired with no activity from the next waiting party 124, the copier 170 is automatically made available to the second waiting party, etc., in the queue 120. Upon arrival of the next waiting party 124, the use-request entry device 125 may be used to record the start of a new job.

Additionally, the device status monitor 110 further includes a device problem monitor 150 that is configured to report a problem with the multi-user device 170. For example, when the multi-user device 170 is a copier, a device problem may be: out of paper, out of toner, or device jammed, etc. Of course, the problems associated with other multi-user devices will be different. The present user indicator 160 is coupled to the waiting party informant 130 and the device status monitor 110. The waiting party informant 130 is further configured to alert the present user 161 when the device problem monitor 150 reports the device problem. Of course, in place of the present user 161, the alert may alternatively be sent to a copier maintenance section (not shown) who is charged with correcting malfunctions.

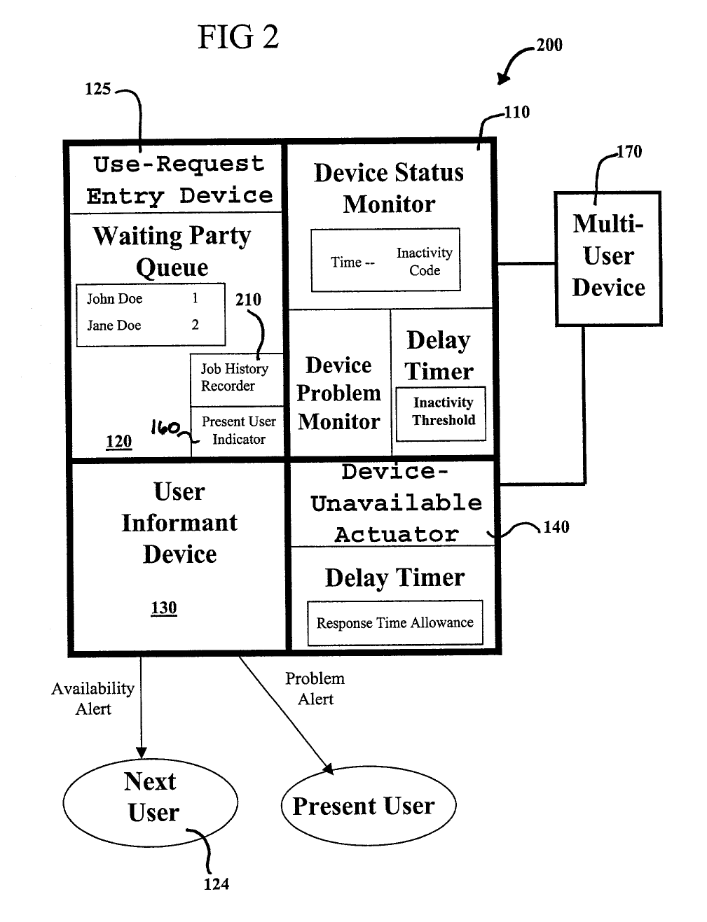

Referring now to FIG. 2, illustrated is a block diagram of an alternative embodiment 200 of the device-available alerting apparatus of FIG. 1. In the illustrated embodiment, the device-available alerting apparatus 200 additionally comprises a job history recorder 210. The job history recorder 210 is coupled to the waiting party queue 120 and the multi-user device 170 through the device status monitor 110. This embodiment is especially useful for multi-user copiers or other such devices. The job history recorder 210 tracks the waiting party queue 120 and the activity of the multi-user device 170 to record each individual and the size of their job so that specific departments may be billed individually for their usage, thereby more accurately reflecting the usage of the multi-user device 170 by each department or project.

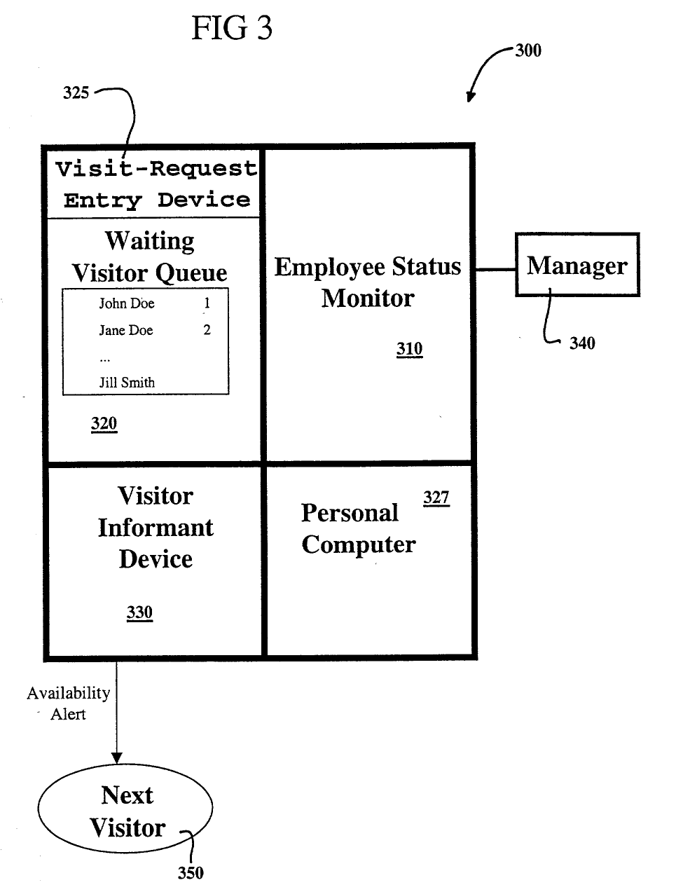

Referring now to FIG. 3, illustrated is a block diagram of an alternative embodiment 300 of the device-available alerting apparatus of FIG. 1. In this embodiment of the present invention, the alerting apparatus 300 comprises an employee status monitor 310, a waiting party queue 320, a visit-request entry device 325, a waiting party informant 330, and a personal computer 327. The visit-request entry device 325 may be a badge reader 325 at the entrance to the office of a manager 340, engineer, etc. For ease of reference and understanding during the remainder of this discussion, the manager 340, engineer, etc. will be represented as the manager 340. As an example, an employee 350, upon visiting the office, learns that the manager 340 is not available as tracked by the personal computer 327 or similar tracking device. The employee 350 may then use the badge reader 325, or other visit-request entry device, to quickly enter their information into the waiting party queue 320. This entry indicates that the employee 350 wishes to meet with the manager 340 at the manager's earliest available time. Of course, other forms of the visit-request entry device 325 may also be used. Alternatively, the manager's status may be kept on the computer 327 in a file that is accessible through a network (not shown) to the employee 350 and the manager 340, and the visit request is therefore logged on-line. When the manager 340 returns, he/she may simply swipe their badge through the badge reader 325 indicating to the employee status monitor 310 that he/she is available. Alternatively, the manager 340 may check the waiting party queue 320 on his networked personal computer 327 to determine who is requesting a visit, and decide accordingly to assign priority to one or more waiting parties, overriding the first-come, first-served queue 320. The waiting party informant 330 then notifies the next waiting party 350 that the manager 340 is available. Of course, other methods of updating the manager's status, such as a Bluetooth-capable wireless device, may also be used. Likewise, various modifications to elements of the basic invention may be made to adapt their fundamental operation to the manager/engineer-available alerting system described above.

Although the present invention has been described in detail, those skilled in the art should understand that they can make various changes, substitutions and alterations herein without departing from the spirit and scope of the invention in its broadest form.

What is claimed is:

1. For use with a multi-user device, an availability alerting apparatus, comprising:
a device status monitor coupled to a multi-user device and configured to report an inactivity of said multi-user device;
a waiting party queue configured to collect waiting party identifiers; and
a waiting party informant coupled to said device status monitor and said waiting party queue, said waiting party informant configured to alert a one of said waiting parties when said device status monitor reports said inactivity.

2. The availability alerting apparatus as recited in claim 1 further comprising a use-request entry device coupled to said waiting party queue and configured to receive said waiting party identifiers.

3. The availability alerting apparatus as recited in claim 2 wherein said use-request entry device is selected from the group consisting of:
an employee badge reader;
an employee selector;
a numeric key entry device;
an alphameric key entry device;
a voice recognition device; and
a biometric identification device.

4. The availability alerting apparatus as recited in claim 1 wherein said device status monitor includes a delay timer having an inactivity threshold, said device status monitor configured to delay reporting said inactivity until said inactivity threshold has been exceeded.

5. The availability alerting apparatus as recited in claim 1 wherein said device status monitor further includes a device problem monitor configured to report a device problem, said device problem comprising: out of paper, out of toner, or device jammed.

6. The availability alerting apparatus as recited in claim 5 further comprising a present user indicator coupled to said waiting party informant and said device status monitor, said waiting party informant further configured to alert said present user when said device problem monitor reports said device problem.

7. The availability alerting apparatus as recited in claim 1 wherein said waiting party queue includes a priority indicator configured to associate a priority with at least one of said waiting party identifiers.

8. The availability alerting apparatus as recited in claim 1 wherein said waiting party informant is selected from the group consisting of:
a telephone messager;
a pager messager;
an e-mail messager;
a Bluetooth-coupled messager; and
an audible pager.

9. The availability alerting apparatus as recited in claim 1 further comprising a device-unavailable actuator coupled to said multi-user device and said waiting party informant, said device-unavailable actuator configured to prevent a user other than said one of said waiting parties from using said multi-user device.

10. The availability alerting apparatus as recited in claim 1 where in said multi-user device is selected from the group consisting of:
a photocopier;
a printer;
a facsimile device;
a microwave; and
a coffee maker.

11. A method of manufacturing an availability alerting apparatus, comprising:
providing a device status monitor and configuring said device status monitor to report an inactivity of a multi-user device;
configuring a waiting party queue to collect waiting party identifiers;
coupling a waiting party informant to said device status monitor and said waiting party queue, and
configuring said waiting party informant to alert a one of said waiting parties when said device status monitor reports said inactivity.

12. The method as recited in claim 11 further comprising coupling a use-request entry device to said waiting party queue and configuring said use-request entry device to receive said waiting party identifiers.

13. The method as recited in claim 11 wherein coupling a use-request entry device includes coupling a use-request entry device selected from the group consisting of:
an employee badge reader;
an employee selector;
a numeric key entry device;
an alphameric key entry device;
a voice recognition device; and
a biometric identification device.

14. The method as recited in claim 11 wherein providing includes providing a device status monitor including a delay timer having an inactivity threshold, said device status monitor configured to delay reporting said inactivity until said inactivity threshold has been exceeded.

15. The method as recited in claim 11 wherein providing includes providing a device status monitor including a device problem monitor configured to report a device problem, said device problem comprising: out of paper, out of toner, or device jammed.

16. The method as recited in claim 5 further comprising coupling a present user indicator to said waiting party informant and said device status monitor, and further configuring said waiting party informant to alert said present user when said device problem monitor reports said device problem.

17. The method as recited in claim 11 wherein configuring a waiting party queue includes configuring a waiting party queue including a priority indicator configured to associate a priority with at least one of said waiting party identifiers.

18. The method as recited in claim 11 wherein coupling a waiting party informant includes coupling a waiting party informant selected from the group consisting of:
a telephone messager;
a pager messager;
an e-mail messager;
a Bluetooth-coupled messager; and
an audible pager.

19. The method as recited in claim 11 further comprising coupling a device-unavailable actuator to said multi-user device and said waiting party informant, said device-unavailable actuator configured to prevent a user other than said one of said waiting parties from using said multi-user device.

20. The method as recited in claim 11 wherein configuring said device status monitor to report an inactivity of a multi-user device includes configuring said device status monitor to report an inactivity of a multi-user device selected from the group consisting of:
a photocopier;
a printer;
a facsimile device;
a microwave; and
a coffee maker.

21. A method of using an availability alerting apparatus, comprising:
reporting an inactivity of a multi-user device with a device status monitor coupled to said multi-user device;
collecting waiting party identifiers in a waiting party queue; and
alerting, with a waiting party informant coupled to said device status monitor, a waiting party associated with a one of said waiting party identifiers when said device status monitor reports said inactivity.

22. The method as recited in claim 21 further comprising receiving said waiting party identifiers with a use-request entry device coupled to said waiting party queue.

23. The method as recited in claim 22 wherein receiving includes receiving wherein said use-request entry device is selected from the group consisting of:
an employee badge reader;
an employee selector;
a numeric key entry device;
an alphameric key entry device;
a voice recognition device; and
a biometric identification device.

24. The method as recited in claim 21 wherein reporting includes reporting wherein said device status monitor includes a delay timer having an inactivity threshold, said device status monitor configured to delay reporting said inactivity until said inactivity threshold has been exceeded.

25. The method as recited in claim 21 wherein reporting includes reporting wherein said device status monitor further includes a device problem monitor configured to report a device problem, said device problem comprising: out of paper, out of toner, or device jammed.

26. The method as recited in claim 25 further comprising alerting a present user when said device problem monitor reports said device problem.

27. The method as recited in claim 21 wherein collecting includes collecting wherein said waiting party queue includes a priority indicator configured to associate a priority with at least one of said waiting party identifiers.

28. The method as recited in claim 21 wherein alerting includes alerting wherein said waiting party informant is selected from the group consisting of:
a telephone messager;
a pager messager;
an e-mail messager;
a Bluetooth-coupled messager; and
an audible pager.

29. The method as recited in claim 21 further comprising preventing a user other than said one of said waiting parties from using said multi-user device with a device-unavailable actuator.

30. The method as recited in claim 21 wherein reporting includes reporting wherein said multi-user device is selected from the group consisting of:
a photocopier;
a printer;
a facsimile device;
a microwave; and
a coffee maker.
